(19) United States
(12) Patent Application Publication
(10) Pub. No.: US 2007/0121432 A1
(43) Pub. Date: May 31, 2007

(54) Apparatus and method for providing secure time, apparatus and method for securely reproducing contents using the secure time, and method of securely transmitting data using the secure time

(75) Inventor: Chi-hurn Kim, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/589,163

(22) Filed: Oct. 30, 2006

(30) Foreign Application Priority Data
Nov. 29, 2005 (KR) 10-2005-0115054

(51) Int. Cl. G11B 7/085

(52) U.S. Cl. 369/30.22

(57) ABSTRACT

An apparatus and a method for providing secure time, an apparatus and a method for securely reproducing contents using the secure time, and a method of securely transmitting data using the secure time. The apparatus for providing the secure time includes a clock whose time can be changed, a time difference storing unit storing a time difference between the correct time and the time of the clock, a time difference setting unit performing a time difference setting process of calculating a time difference and storing the time difference in the time difference storing unit when the time of the clock is changed, and a time providing unit providing the correct time by using the time of the clock and the time difference. Advantages of user convenience and cost savings can be obtained through the use of a single clock whose time can be freely changed by a user. A secure clock that can provide the correct time can be embodied as a software program.

### CROSS-REFERENCE TO RELATED PATENT APPLICATION

This application claims the benefit of Korean Patent Application No. 10-2005-0115054, filed on Nov. 29, 2005, in the Korean Intellectual Property Office, the disclosure of which is incorporated herein in its entirety by reference.

### BACKGROUND OF THE INVENTION

1. Field of the Invention

The present invention relates to security of data, and more particularly, to an apparatus and a method for providing secure time, an apparatus and a method for securely reproducing contents using the secure time, and a method of securely transmitting data using the secure time.

2. Description of the Related Art

A Digital Rights Management (DRM) system is a system for providing security of data. A recent DRM system employs a method in which a period of time is set in which contents can be used, and the contents are allowed to be used when the current time is within the set period. Such a DRM system requires the current time to be correctly determined.

There are two cases when the current time is determined. One is when the time of a clock cannot be changed by a user and the other is when the time of a clock can be changed by the user. When a clock whose time cannot be changed is used, another clock is required for user convenience. When a clock whose time can be changed is used, illegal use of contents by freely changing the time of the clock may occur.

Thus, it is necessary to provide a clock whose time can not only be freely changed in terms of user convenience, but also be reliable in terms of reproducing contents in the DRM system. Reliable time used in the DRM system is defined as secure time and a clock providing the secure time is defined as a secure clock, according to the present invention.

### SUMMARY OF THE INVENTION

The present invention provides an apparatus and a method for enabling a user to freely change time and providing secure time to make the time reliable, and a computer-readable recording medium storing a program for performing the method in a computer.

The present invention also provides an apparatus and a method for securely reproducing contents by using the secure time, and a computer-readable recording medium recording a program for performing the method.

The present invention also provides a method of securely transmitting data by using the secure time, and a computer-readable recording medium recording a program for performing the method.

According to an aspect of the present invention, there is provided an apparatus for providing secure time, the apparatus comprising: a clock whose time can be changed; a time difference storing unit storing a time difference between the correct time and a time of the clock; a time difference setting unit performing a time difference setting process of calculating the time difference and storing the time difference in the time difference storing unit when the time of the clock is changed; and a time providing unit providing the correct time by using the time of the clock and the time difference.

According to another aspect of the present invention, there is provided a method of providing secure time, the method comprising: performing a time difference setting process of calculating and storing a time difference between the correct time and a time of a clock whose time can be changed when the time of the clock is changed; and calculating and providing the correct time by using the time of the clock and the time difference.

According to another aspect of the present invention, there is provided an apparatus for reproducing contents, the apparatus comprising: a clock whose time can be changed; a time difference storing unit storing a time difference between the correct time and a time of the clock; a time difference setting unit performing a time difference setting process of calculating the time difference and storing the time difference in the time difference storing unit when the time of the clock is changed; a time providing unit providing the correct time by using the time of the clock and the time difference; and a contents reproducing unit allowing the contents to be reproduced only when the correct time provided by the time providing unit is within a period of time allowing reproduction of contents.

According to another aspect of the present invention, there is provided a method of reproducing contents, the method comprising: performing a time difference setting process of calculating and storing a time difference between the correct time and a time of a clock whose time can be changed when the time of the clock is changed; calculating the correct time by using the time of the clock and the time difference; and allowing the contents to be reproduced only when the calculated correct time is within a period of time allowing reproduction of contents.

According to another aspect of the present invention, there is provided a method of transmitting data, the method comprising: performing a time difference setting process of calculating and storing a time difference between the correct time and a time of a clock whose time can be changed when the time of the clock is changed; calculating the correct time by using the time of the clock and the time difference; requesting transmission of a current time from a data receiving unit; receiving the current time from the data receiving unit; comparing the calculated correct time and the current time received from the data receiving unit and determining whether a difference between the calculated correct time and the current time received from the data receiving unit is within an allowable tolerance range; and transmitting data to the data receiving unit when the difference between the calculated correct time and the current time received from the data receiving unit is within an allowable tolerance range.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a configuration of a contents-using apparatus employing a DRM system using a clock whose time cannot be changed;

FIG. 2 is a diagram illustrating a configuration of a contents-using apparatus employing a DRM system using a clock whose time can be changed;

FIG. 3 is a block diagram illustrating a configuration of an apparatus for providing secure time according to an embodiment of the present invention;

FIG. 4 is a block diagram illustrating a configuration of an apparatus for providing secure time according to another embodiment of the present invention;

FIG. 5 is a diagram for illustrating a process of setting a time difference by exchanging time information with an external time server;

FIG. 6 is a diagram illustrating a process of setting a time difference when a time difference setting process was previously performed; and

FIG. 7 is a flowchart illustrating a method of securely transmitting data according to an embodiment of the present invention.

### DETAILED DESCRIPTION OF THE INVENTION

Embodiments of the present invention will now be described more fully with reference to the accompanying drawings.

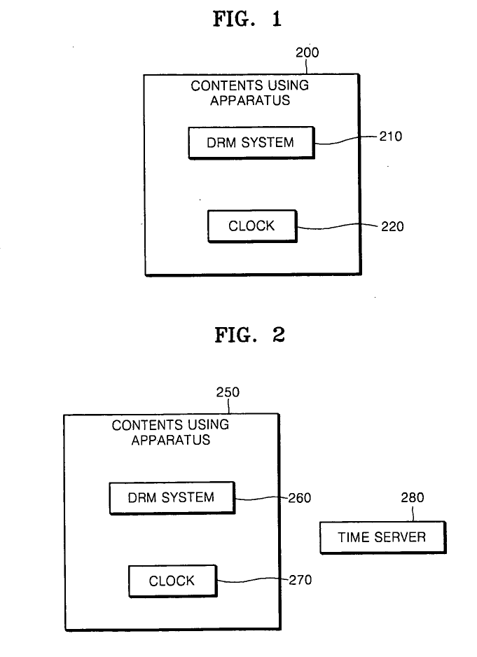

FIG. 1 is a diagram illustrating a configuration of a contents-using apparatus 200 employing a DRM system using a clock whose time cannot be changed. Referring to FIG. 1, the contents-using apparatus 200 includes a DRM system 210 and a clock 220 whose time cannot be changed.

The DRM system 210 using the clock 220, whose time cannot be changed, as illustrated in FIG. 1, increases the cost of preventing a user from changing the time of the clock 220 since it requires another clock to meet a user's need for a clock whose time can be changed. Separate clocks are required for the DRM system and the user, respectively.

FIG. 2 is a diagram illustrating a configuration of a contents-using apparatus 250 employing a DRM system using a clock whose time can be changed. Referring to FIG. 2, the contents-using apparatus 250 includes a DRM system 260 and a clock 270 whose time can be changed. For convenience of explanation, an external time server 280 is illustrated as well.

The clock 270, whose time can be changed, is initially synchronized with the external time server 280. The DRM system 260 detects a rollback when a user changes the time of the clock 270 after initial synchronization, more specifically when a rollback occurs. The operation of the DRM system 260 depends on whether a rollback has occurred. When the rollback has not occurred, the DRM system 260 relies on the time of the clock and operates according to that time. When a rollback occurs, the clock 270 is again synchronized with the external time server 280 because the time of the clock 270 is unreliable. When synchronization is not possible, the DRM system 260 does not perform the requested operation.

A user may change the time of the clock 270 by 10 minutes earlier or later than the correct time. When the user changes the time of the clock 270 for that reason, the DRM system 260 detects the rollback. Accordingly; the DRM system 260 connects to the external time server 280 whenever it performs an operation requiring the correct time. Thus, a user may need to connect to the Internet whenever he/she reproduces contents. The DRM system 260 cannot perform an operation requiring the correct time if it cannot be connected to the external time server 280 due to network problems. This is a troublesome situation for a user.

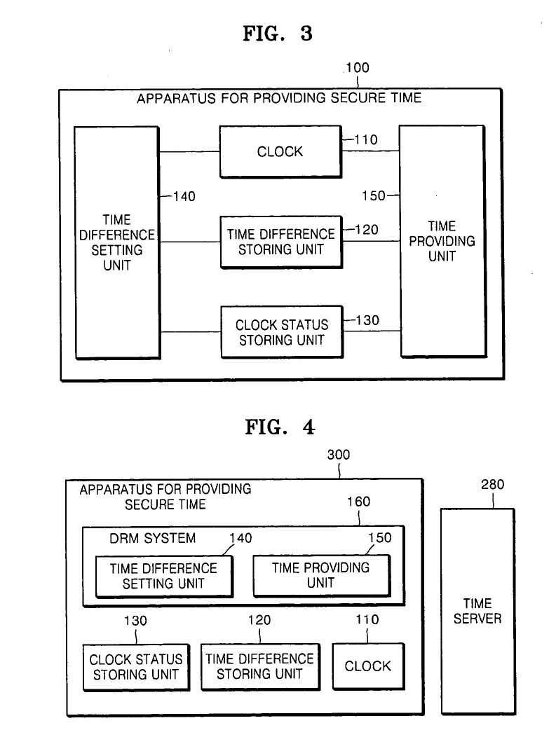

FIG. 3 is a block diagram illustrating a configuration of an apparatus 100 for providing secure time according to an embodiment of the present invention. Referring to FIG. 3, the apparatus 100 for providing secure time according to the present time includes a clock 110, a time difference storing unit 120, a clock status storing unit 130, a time difference setting unit 140, and a time providing unit 150.

FIG. 4 is a block diagram illustrating a configuration of an apparatus 300 for providing secure time according to another embodiment of the present invention. FIG. 4 explicitly illustrates a DRM system 160 including a time difference setting unit 140 and a time providing unit 150. Accordingly, in the embodiment of FIG. 4, the DRM system 160 operates the time difference setting unit 140 and the time providing unit 150.

Elements of the apparatus 300 for providing secure time, as illustrated in FIG. 4, are identical to those of the apparatus 100 for providing secure time, as illustrated in FIG. 3. Therefore, the following description applies to both FIG. 3 and FIG. 4.

The apparatuses 100 and 300 for providing secure time use a clock 110 whose time can be changed. The time of the clock may be directly changed by a user, or by a program operating on a system. The clock 110 includes a physical clock and a clock control unit controlling the physical clock. The apparatuses 100 and 300 for providing secure time according to embodiments of the present invention may be operated at a device driver level of the clock in order to guarantee security of data.

The concept of a time difference is used according to an embodiment of the present invention. The time difference is a difference between the correct time and the time of the clock 110. A user may want to change the time of the clock 110 to be different from the correct time, as described above. The difference between the set time of the clock 110 and the correct time is defined as a time difference.

The time difference storing unit 120 stores the time difference.

A time difference setting unit 140 calculates the time difference and stores the time difference when the time of the clock 110 is changed. The operation of the time difference setting unit 140 in calculating the time difference and storing the time difference in the time difference storing unit 120 is defined as a time difference setting process according to an embodiment of the present invention.

After the time of the clock 110 is changed, initiation of a time difference value is requested if a time difference setting did not occur before, or adjustment of the time difference is necessary if a time difference setting has occurred, and more specifically when a rollback has occurred.

Each case requires different operations. As such, the apparatus 100 for providing secure time, illustrated in FIG. 3 and FIG. 4, must know if the time difference setting occurred. Therefore, a clock status variable indicating whether the time difference setting process has occurred is stored in the clock status storing unit 130.

According to an embodiment of the present invention, the clock status variable has a value of 0 when the time difference setting has not been performed before and has a value of 1 when the time difference setting has been performed before. An example of when the time difference setting has not been performed before includes the case where a hardware reset of the apparatuses 100 and 300 for providing secure time has occurred. A typical example of a hardware reset is a power supply failure in the apparatuses 100 and 300. When a hardware reset has happened, the time of the clock 110 becomes unreliable because the clock 110 has a different time from the correct time.

Initiation of the time difference value is can thus be required when the time difference setting has not been performed before. At this time, the time difference setting is performed based on a time of an external time server 280 because there is no reference time to refer to.

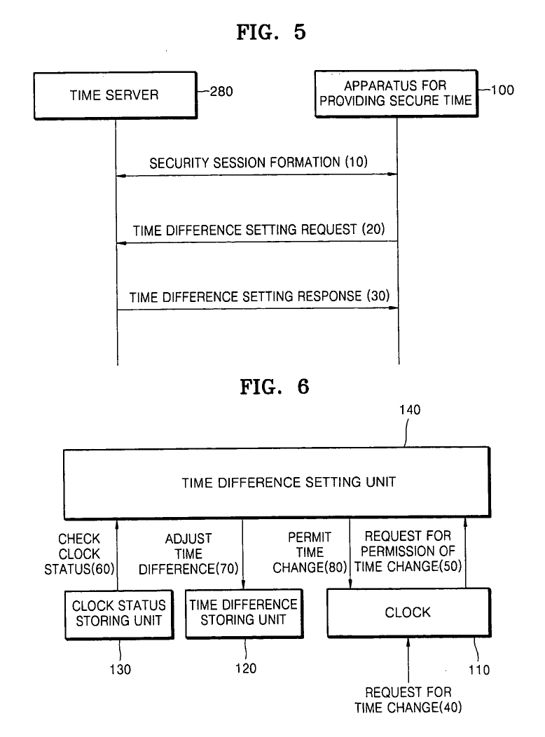

FIG. 5 is a diagram illustrating a process of setting a time difference by exchanging time information with the external time server 280. The time difference setting, depending on an exchange of time information with the external time server 280, basically includes a time difference setting request 20 and a time difference setting response 30. A security session 10 may be formed to guarantee no defect in data transmitted from the time difference setting request 20 and the time difference setting response 30. Furthermore, other encryption methods may be used.

There are two methods of setting the time difference through the exchange of time information with the external time server 280. One method is where the external time server 280 calculates the time difference. The other method is where the apparatus 100 for providing secure time calculates the time difference.

Described below is the method where the external time server 280 calculates the time difference. The apparatus 100 for providing secure time sends a time difference setting message to the external time server 280. The time difference setting message includes a time of the clock 110, in order for the external time server 280 to calculate the time difference. The external time server 280 extracts the time of the clock 110 from the received time difference setting message and calculates the time difference between the correct time of the external time server 280 and the time of the clock 110. The external time server 280 sends a time difference setting response message including the calculated time difference to the apparatus 100. The apparatus 100 for providing secure time extracts the time difference and stores the time difference in the time difference storing unit 120 after receiving the time difference setting response message.

Described below is the method where the apparatus 100 for providing secure time directly calculates the time difference. The apparatus 100 for providing secure time is required to receive the correct time from the external time server 280 in order to calculate directly the time difference. To that end, the apparatus 100 for providing secure time first sends to the external time server 280 a time difference setting request message requesting the external time server 280 to transmit the correct time of the external time server 280. The external time server 280 sends a time difference setting response message including the time of the external time server 280 to the apparatus 100. The apparatus 100 extracts the time of the external time server 280 from the received time difference response message, calculates a difference between the time of the external time server 280 and the time of the clock 110, and sets the difference as a time difference.

A roll back occurs when the time of the clock 110 is changed and the clock status variable of the clock status storing unit 130 has a value of 1. The apparatus 100 according to the current embodiment of the present invention allows for the change in the time of the clock 110, and adds a changed amount of time to the time of the clock 110 or subtracts the changed amount of time from the time of the clock 110 when a rollback occurs.

FIG. 6 is a diagram illustrating a process of setting a time difference when a time difference was previously set. When a user or software requests a change in time (40), the clock 110 requests a time difference setting unit 140 to allow for a change in time (50). The time difference setting unit 140 identifies a value of the time status variable stored in a clock status storing unit 130 (60) and confirms if a time difference has been previously set. A current time difference is reliable when the time difference has been previously set. Accordingly, the time difference is adjusted by an amount of time to be changed at the request of the clock 110 (70). The time difference setting unit 140 allows the clock 110 to change the time (80) after the time difference is changed. The clock 110 changes the time when receiving time change permission.

As described above, the time difference setting unit 140 may be included in the DRM system 160 illustrated in FIG. 4. Furthermore, the clock 110 may include a physical clock and a clock control unit controlling the physical clock. Accordingly, the request for changing time (50), the time difference adjustment (70), the time change permission (80), the change in the time of the clock 110, and so forth are performed at the level of a device driver. Therefore, a user is not allowed to change the time of the clock 110 without adjustment of the time difference, thereby maintaining reliability of the time of the clock 110.

A time providing unit 150 provides the correct time by using the time of the clock 110 and the time difference stored in the time difference storing unit 120. In a normal situation, where the time difference was set, a time value resulting from adding the time difference to the time of the clock 110 indicates the correct time. However, a time value resulting from adding the time difference to the time of the clock 110 does not indicate the correct time when the time difference was not previously set, such as when a hardware reset was performed.

In an embodiment in which the clock status variable is 1 when the time difference has been performed previously, and the clock status variable is 0 when the time difference has not been previously set, the time providing unit 150 can provide the correct time that is obtained by multiplying the value of the clock status variable by the sum of the time of the clock 110 and the time difference. The correct time can be expressed as following Equation 1.
T=(t+Δt)×(value of clock status variable) (Equation 1)
where t is the time of the clock 110, Δt is the time difference, and T is the correct time provided by the time providing unit 150.

Value T=0 indicates that the time provided by the time providing unit 150 is not the correct time, when Equation 1 is applied in the time providing unit 150.

The apparatuses 100 and 300 for providing secure time according to embodiments of the present invention can provide the correct time by calculating and storing the time difference and providing as a current time the sum of the time difference and the time of the clock 110 if necessary, through the use of a single clock whose time can be freely changed by a user. Thus, the secure clock can be embodied in terms of software.

Contents and data can be securely reproduced and transmitted, respectively, by using a secure clock embodied using a method of providing secure time according to the present invention.

An example of securely reproducing contents in a DRM system is described below. Secure reproducing of contents allows a user to reproduce contents only when current time is within a period of time allowing for reproduction of contents if the period of time allowing for reproduction of the contents is set within the contents.

A user may have intention to change the time of a clock to make the time included in the period of time allowing for reproduction of contents, for the illegal purpose of reproducing the contents after the period of time allowing for reproduction of contents expires. As illustrated, this is known as rollback. A DRM system that does not employ a method of providing secure time according to an embodiment of the present invention either employs a clock whose time cannot be changed as illustrated in FIG. 1, or performs time synchronization with an external time server whenever the correct time is required, as illustrated in FIG. 2, in order to prevent illegal activities.

However, a method of providing secure time according to an embodiment of the present invention not only enables a user to freely change the time of the clock, but also makes it possible to provide the correct time and determine a period of time allowing for reproduction of contents. To that end, first, the method of providing secure time is performed, and a user is allowed to reproduce contents only when the provided secure time is within the period of time allowing for reproduction of contents.

Described below is a method of securely transmitting data. Secure transmitting allows data to be transmitted only when the time of a data transmitting device and the time of a data receiving device are reliable to the data receiving device and the data transmitting device, respectively. However, the time of the data transmitting device does not need to be identical to the time of the data receiving device. Data transmitting is possible when a time difference between the data transmitting device and the data receiving device is within an allowable tolerance range. More specifically, reliability between the data transmitting device and the data receiving device can be established when there is a small time difference between the two devices.

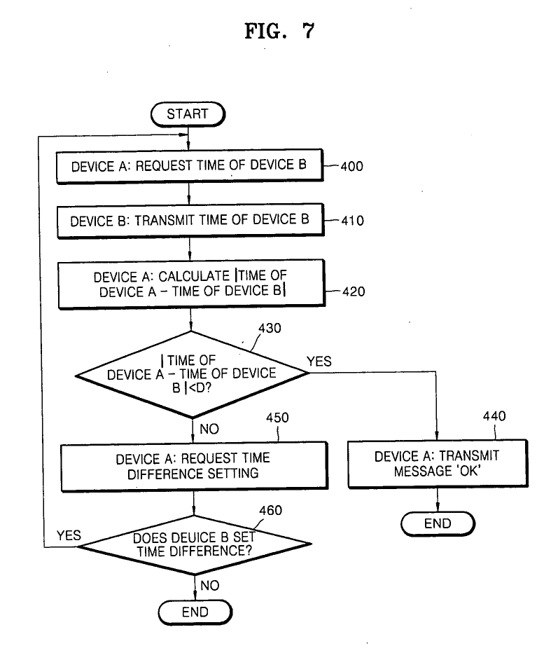

FIG. 7 is a flowchart illustrating a method of securely transmitting data according to an embodiment of the present invention. Referring to FIG. 7, data is transmitted only when device A can trust the time of device B.

First, the device A requests the device B to transmit the time of the device B (400). The device B transmits the time of the device B (410). The device A compares the time of the device A provided by an apparatus for providing secure time and the time of the device B received from the device B (420) and determines whether the time difference between the devices A and B is within an allowable tolerance range, or more specifically, smaller than value D (430).

The device A trusts the time of the device B, and performs a scheduled operation of transmitting data when the time difference between the devices A and B is within the allowable tolerance range D. An ‘OK’ message may be sent to the device B before transmitting data, as illustrated in FIG. 7 (440).

The device A requests the device B to perform time difference setting because the time of the device B cannot be trusted if the time difference is not within the allowable tolerance range D (450). When the device B sets the time difference (460), operations 400, 410, 420, 430, and 440 are sequentially repeated. Data cannot be transmitted when the device B does not set the time difference.

The method and apparatus for providing secure time according to the present invention is applicable to many fields relating to data security in addition to secure reproducing of contents and secure transmission of data. The method of providing secure time according to the present invention is applicable when a specific operation should be performed only if devices can mutually trust each other's time.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

According to the method and the apparatus for providing secure time, it is possible to provide user convenience and to save cost through the use of a single clock whose time can be freely changed by a user. Also, it is possible to provide the correct time by calculating and storing the time difference and providing as a current time the sum of the time difference and the time of the clock if necessary. Accordingly, the secure clock can be embodied in terms of software. Furthermore, it is possible to reproduce contents by using the secure time and to provide a reliable time when a specific operation is performed only if devices can trust the time setting.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for providing secure time, the apparatus comprising:
a clock whose time can be changed;
a time difference storing unit storing a time difference between the correct time and a time of the clock;
a time difference setting unit performing a time difference setting process of calculating the time difference and storing the time difference in the time difference storing unit when the time of the clock is changed; and
a time providing unit providing the correct time by using the time of the clock and the time difference.

2. The apparatus of claim 1, wherein the time difference setting unit sets as the time difference a time difference between the time of an external time server and the time of the clock when the time difference setting process has not been previously performed.

3. The apparatus of claim 2, wherein the time difference setting unit comprises a time server connecting unit transmitting a time difference setting request message comprising the time of the clock to the external time server and receiving a time difference setting response message comprising a time difference calculated by the external time server from the external time server.

4. The apparatus of claim 2, wherein the time difference setting unit comprises:
a time server connecting unit transmitting the time difference setting request message requesting the external time server to transmit the time of the external time server and receiving the time difference setting response message comprising the time of the external time server from the external time server; and
a time difference calculating unit calculating a difference between the time of the external time server and the time of the clock and setting the difference as the time difference.

5. The apparatus of claim 1, wherein the time difference setting unit increases or decreases the time difference by a changed amount of time of the clock when the time difference setting has been previously performed.

6. The apparatus of claim 1, further comprising a clock status storing unit storing a clock status variable indicating whether the time difference setting process has been previously performed.

7. The apparatus of claim 6, wherein the clock status storing unit sets the value of a time status variable to 1 when the time difference setting process is performed.

8. The apparatus of claim 7, wherein the time providing unit provides as the correct time a value resulting from multiplying the value of the time status variable by the sum of the time of the clock and the time difference.

9. The apparatus of claim 7, wherein the value of the time status variable is set to 0 when a hardware reset occurs in the apparatus.

10. The apparatus of claim 9, wherein the hardware reset occurs due to a power supply failure of the apparatus.

11. A method of providing secure time, the method comprising:
performing a time difference setting process of calculating and storing a time difference between the correct time and a time of a clock whose time can be changed when the time of the clock is changed; and
calculating and providing the correct time by using the time of the clock and the time difference.

12. The method of claim 11, wherein performing the time difference setting process comprises setting as the time difference a difference between the time of an external time server and the time of the clock when the time difference setting process has not been previously performed.

13. The method of claim 12, wherein performing the time difference setting process comprises:
transmitting a time difference setting request message comprising the time of the clock to the external time server;
receiving a time difference setting response message comprising a time difference calculated by the external time server from the external time server; and
storing the time difference calculated by the external time server.

14. The method of claim 12, wherein performing the time difference setting process comprises:
transmitting a time difference setting request message requesting the external time server to transmit the time of the external time server;
receiving a time difference setting response message comprising the time of the external time server from the external time server; and
calculating a difference between the time of the external time server and the time of the clock and storing the difference.

15. The method of claim 11, wherein performing the time difference setting process comprises increasing or decreasing the time difference by a changed amount of time of the clock when the time difference setting process has been previously performed.

16. The method of claim 11, further comprising storing a clock status variable indicating whether the time difference setting process has been previously performed.

17. The method of claim 16, wherein the storing the clock status variable comprises setting the clock status variable as 1 when the time difference setting process has been previously performed.

18. The method of claim 17, wherein the calculating and providing the correct time comprises providing as the correct time a value resulting from multiplying the value of the time status variable by the sum of the time of the clock and the time difference.

19. A computer-readable recording medium storing a program for performing a method of providing secure time, the method comprising:
performing a time difference setting process of calculating and storing a time difference between the correct time and a time of a clock whose time can be changed when the time of the clock is changed; and
calculating and providing the correct time by using the time of the clock and the time difference.

20. An apparatus for reproducing contents, the apparatus comprising:
a clock whose time can be changed;
a time difference storing unit storing a time difference between the correct time and a time of the clock;
a time difference setting unit performing a time difference setting process of calculating the time difference and storing the time difference in the time difference storing unit when the time of the clock is changed;
a time providing unit providing the correct time by using the time of the clock and the time difference; and
a contents reproducing unit allowing the contents to be reproduced only when the correct time provided by the time providing unit is within a period of time allowing reproduction of contents.

21. A method of reproducing contents, the method comprising:
performing a time difference setting process of calculating and storing a time difference between the correct time and a time of a clock whose time can be changed when the time of the clock is changed;
calculating the correct time by using the time of the clock and the time difference; and
allowing the contents to be reproduced only when the calculated correct time is within a period of time wherein reproduction of contents is permitted.

22. A computer-readable recording medium recording a program for performing a method of reproducing contents, the method comprising:
performing a time difference setting process of calculating and storing a time difference between the correct time and a time of a clock whose time can be changed when the time of the clock is changed;
calculating the correct time by using the time of the clock and the time difference; and
allowing the contents to be reproduced only when the calculated correct time is within a period of time wherein reproduction of contents is permitted.

23. A method of transmitting data, the method comprising:
performing a time difference setting process of calculating and storing a time difference between the correct time and a time of a clock whose time can be changed when the time of the clock is changed;
calculating the correct time by using the time of the clock and the time difference;
sending a request for transmitting a current time to a data receiving unit;
receiving the current time from the data receiving unit;
comparing the calculated correct time and the current time received from the data receiving unit and determining whether a difference between the calculated correct time and the current time received from the data receiving unit is within an allowable tolerance range; and
transmitting data to the data receiving unit when the difference between the calculated correct time and the current time received from the data receiving unit is within an allowable tolerance range.

24. The method of claim 23, further comprising:
requesting the data receiving unit to perform a time difference setting process when the difference between the calculated current time and the current time received from the data receiving unit is not within an allowable tolerance range; and
requesting the data receiving unit to transmit again a current time when the data receiving unit has performed the time difference setting process.

25. A computer-readable recording medium recording a program for performing a method of transmitting data, the method comprising:
performing a time difference setting process of calculating and storing a time difference between the correct time and a time of a clock whose time can be changed when the time of the clock is changed;
calculating the correct time by using the time of the clock and the time difference;
sending a request for transmitting a current time to a data receiving unit;
receiving the current time from the data receiving unit;
comparing the calculated correct time and the current time received from the data receiving unit and determining whether a difference between the calculated correct time and the current time received from the data receiving unit is within an allowable tolerance range; and
transmitting data to the data receiving unit when the difference between the calculated correct time and the current time received from the data receiving unit is within an allowable tolerance range.
